(19) United States
(12) Patent Application Publication
(10) Pub. No.: US 2020/0246922 A1
(43) Pub. Date: Aug. 6, 2020

(54) DEVICE AND METHOD FOR PROCESSING A GAS TURBINE COMPONENT

(71) Applicant: Lufthansa Technik AG, Hamburg (DE)

(72) Inventors: Christoph Schwienbacher, Luedinghausen (DE); Michael Ernst, Hamburg (DE); Thiemo Ullrich, Heidgraben (DE); Thorsten Schueppstuhl, Dortmund (DE)

(21) Appl. No.: 15/769,758

(22) PCT Filed: Oct. 20, 2016
(86) PCT No.: PCT/EP2016/075225

§ 371 Date: Apr. 20, 2018

(30) Foreign Application Priority Data
Oct. 21, 2015 (DE) 10 2015 220 525.8

(51) Int. Cl. B23P 6/00; B25J 9/16; B25J 11/00; G05B 19/19

(52) U.S. Cl. CPC B23P 6/002; B25J 9/1664; B25J 11/005; G05B 2219/50052; G05B 2219/45147; G05B 2219/50049; G05B 19/19

(57) ABSTRACT

An apparatus for processing a component includes a multi-axis positioning device, a processing tool, and a control device for controlling the multi-axis positioning device. The multi-axis positioning device is configured to move the processing tool relative to the component and to move each axis of the processing tool within a corresponding work envelope. The control device is configured to limit the movement of the multi-axis positioning device along or about at least one limited axis within the corresponding work envelope to a subregion or subspace. The multi-axis positioning device and/or the component is configured to move about and/or along an external axis to compensate for the limitation of the movement along or about the limited axis.

### CROSS-REFERENCE TO RELATED APPLICATION

This application is a U.S. National Phase application under 35 U.S.C. § 371 of International Application No. PCT/EP2016/075225, filed on Oct. 20, 2016, and claims benefit of German Patent Application No. DE 10 2015 220 525.8, filed on Oct. 21, 2015. The International Application was published in German on Apr. 27, 2017 as WO 2017/068040 under PCT Article 21(2).

### FIELD

The present invention relates to an apparatus and a method for processing a component.

### BACKGROUND

Aircraft components are subject to high levels of stress during operation. In addition to components made of composite materials, such as structural components, or metal components, such as undercarriage components, this can lead to damaging crack formation in particular in the components of an aircraft engine. Similar damage is also found in other gas turbines, for example in stationary gas turbines. Combustion chamber components are particularly greatly affected by crack formation in gas turbines.

Cracks are local material separations within a structure or within a component. Crack initiation is generally a local occurrence in the microstructure of the surface, which is generally caused by lattice defects in the microstructure or by cyclical operational loading. Cracks generally spread perpendicularly to the normal stress acting thereon. This spreading is referred to as being “controlled by normal stress”.

DE 10 2012 221 782 A1 discloses a method for repairing a gas turbine component in an automated manner, the component being checked in a first method step for cracks by means of an optical measurement method and the geometry and/or damage data determined thereby being stored. An optimum repair strategy for the machining and carrying out of repair welding is then determined in an automated manner on the basis of these data. The component is then checked for cracks by means of an optical measurement method.

So as to position a processing tool, e.g. a machining tool or a welding tool, as accurately as possible, the processing tool can be positioned relative to a component by means of a robot. The robot is typically a six-axis robot by means of which the processing tool can, in theory, reach every point on the component to be processed.

Furthermore, EP 0 271 691 A1, for example, discloses providing, in addition to the axes of the robot, additional external movement axes by means of which the component to be processed can be rotated or titled. The additional external axes increase the size of the workspace of the robot, and therefore the points on the component that are to be processed can be positioned such that they can be reached by the robot. Furthermore, this makes it possible to avoid robot singularities and collisions between the robot and the component.

EP 0 158 447 A1 discloses a six-axis robot which guides a processing tool over a component that is positioned on a rotary table. In this document, the robot movement is simplified by the moving parts of the robot being superimposed on those of the rotary table.

### SUMMARY

An embodiment of the present invention provides for an apparatus for processing a component, the apparatus including a multi-axis positioning device, a processing tool, and a control device for controlling the multi-axis positioning device. The multi-axis positioning device is configured to move the processing tool relative to the component and to move each axis of the processing tool within a corresponding work envelope. The control device is configured to limit the movement of the multi-axis positioning device along or about at least one limited axis within the corresponding work envelope to a subregion or subspace. The multi-axis positioning device and/or the component is configured to move about and/or along an external axis to compensate for the limitation of the movement along or about the limited axis.

### BRIEF DESCRIPTION OF THE DRAWINGS

The present invention will be described in even greater detail below based on the exemplary figures. The invention is not limited to the exemplary embodiments. All features described and/or illustrated herein can be used alone or in combined in different combinations in embodiments of the invention. The features and advantages of various embodiments of the present invention will become more apparent by reading the following detailed description with reference to the attached drawings, which illustrate the following:

FIG. 1 shows an apparatus according to an embodiment of the invention for processing a component;

FIG. 2 is a detailed view of a processing tool positioned in a subspace according to an embodiment of the invention;

FIG. 3 is a side view of a component to be processed according to an embodiment of the invention; and

FIG. 4 shows an example of a component-specific subspace according to an embodiment of the invention.

### DETAILED DESCRIPTION

In combustion chamber components, cracks are initiated as a result of high thermal and mechanical loading. On the one hand, crack formation is caused by the prevailing high temperatures and, on the other hand, the vibrations transferred to the combustion chamber from the upstream and downstream modules, namely the high-pressure compressor and the high-pressure turbine, promote crack growth and crack formation.

In addition, temporary thermal material stresses during start-up of the gas turbine or during the starting phase of the aircraft facilitate crack initiation. Solid particles that are drawn into the gas turbine, such as sand and dust, also contribute greatly to the initiation of cracks on combustion chamber components. Furthermore, the long-lasting thermal loads during the operating phase of the gas turbine lead to a change in the geometric shape of the combustion chamber components.

During maintenance of aircraft and/or gas turbine components, in particular during maintenance of the combustion chamber, the main problem is that of detecting the damage, in particular cracks, produced during operation, and repairing the components using suitable measures. Owing to the shapes of the cracks and damage all being different, this often proves difficult.

Established repair methods comprise an almost completely manual process chain that involves a long and unstable execution time and low reproducibility of the repair results. The manual repair process comprises, for example, the steps of aligning components, milling in order to prepare the welding point, welding and milling in order to rework the welding point. Further processing steps may also be provided, such as that of applying a heat protection layer or heat-treating a component. Ensuring a consistently high level of quality in this manual process is complex, in particular since it has to be ensured and documented that the stringent aviation requirements are met.

Some of the problems are, for example, the inaccuracies that occur when aligning the components and complicated and time-consuming patch repairs, in which a damaged region is completely replaced, and this is also associated with high heat input during a weld repair. The high heat input may cause heat cracks to form and also results in a high level of finishing complexity owing to the high weld allowance. Furthermore, high heat input leads to distortion, which can only be reduced or corrected by complex clamping apparatuses and, in addition, subsequent straightening processes.

In the previously mentioned solutions for processing a component by means of a robot in combination with movement of the component about or along an additional external axis, it is possible to efficiently perform complex movement sequences. The high number of degrees of freedom of the robot can however result in a loss in precision, for example caused by backlash or elastic deformation of robot components, and this is unacceptable particularly when processing aircraft components.

Various calibration methods, including the method described in EP 0 504 590 A1, represent, for example, one way of improving the accuracy of industrial robots. Calibration methods of this kind require that the person performing the calibration has a high level of know-how and require a large outlay in terms of time and measurement technology, and therefore said methods are not efficient for automated processing involving short execution times.

Accordingly, an aspect of embodiments of the invention is to correct positioning and orientation errors and thus improve the precision of automated processing devices having a multi-axis positioning device.

According to an aspect of the invention, an apparatus for processing a component is provided, comprising a multi-axis positioning device, a processing tool and a control device for controlling the positioning device, it being possible for the processing tool to be moved relative to the component by means of the positioning device, it being possible for the processing tool to be moved for each axis within a corresponding work envelope by the positioning device, the control device being designed to limit the movement of the positioning device along or about at least one limited axis within the corresponding work envelope to a subregion or subspace, it being possible to compensate for the limitation of the movement along or about the limited axis by it being additionally possible for the positioning device and/or the component to be moved about and/or along an external axis.

The processing tool is able to be moved in any manner within a workspace by means of the positioning device. The workspace is specified by the possibility of movement along or about each of the movement axes of the positioning device within the corresponding work envelope of the relevant axis. In other words, the workspace is the space which can be reached by the part of the positioning device that accommodates the processing tool.

The positioning device is preferably a six-axis system such that it is possible to reach any processing points on the component to be processed within the workspace. In principle, however, all other types of multi-axis positioning devices that have rotational and/or linear axes may also be used. The positioning device is advantageously a multi-axis robot, in particular a six-axis industrial robot having an additional axis or additional axes.

By restricting the movement of the positioning device to the (one-dimensional) subregion of the relevant axis within the work envelope, a (one-dimensional or multi-dimensional) subspace is delimited that is smaller than the workspace. The movement range of the positioning device is artificially restricted by the control device, and this results in it not being possible for movements along and/or about the limited axis to be performed or in it only being possible for said movements to be performed to a limited extent. This restriction makes it possible to minimise positioning uncertainties along or about the limited axis.

In principle, according to embodiments, it is also possible to use robots of which the workspace substantially forms the subspace, i.e. by being restricted to just one degree of freedom, for example, the positioning device can only be moved within the subspace. It is thus possible, according to embodiments, to use more compact positioning devices that generally cause fewer positioning errors. Alternatively, it is also possible, according to embodiments, to use a plurality of positioning devices each having a processing tool, such that the component can be processed by a plurality of processing tools at the same time, without said tools being able to enter the opposite subspaces and cause collisions.

In order to allow the processing tool to be positioned relative to the component to be processed in an unrestricted manner despite the workspace being limited, the limitation to the subspace artificially imposed by the control device can be compensated for by a possibility (capability) of movement along or about an external axis.

Within the meaning of this application, an “external axis” should be understood to be an axis that is not directly assigned to the positioning device. This axis is preferably an axis that is redundant by comparison with an axis of the positioning device, i.e. an axis that would not actually be required in order for a particular processing point on the component to be reached, since this would already be possible owing to the degrees of freedom of the positioning device itself. More preferably, the external axis is oriented in parallel with an axis of the positioning device.

The external axis is preferably arranged such that the component to be processed can be rotated and/or translated owing to the degree of freedom that is additionally present. Alternatively, the external axis can also be arranged such that the positioning device itself can be rotated and/or translated owing to the degree of freedom that is additionally present. More preferably, any combinations of the external axes are possible for moving the component and the positioning device.

A highly precise support and actuation device is also preferably provided that makes translational and/or rotational movement along and/or about the external axis possible. The movement along and/or about the external axis can thus be performed more accurately, i.e. with fewer positioning errors, than would be possible by the positioning device itself being moved. Thus components can be processed in a more precise and process-stable manner. Collisions with the component can also be prevented more easily.

Embodiments also provide that the movement about and/or along the external axis is controlled by the control device. Therefore, it is the control device that restricts the movement to the subspace and compensates for this restriction. Furthermore, the compensation movement along and/or about the external axis being controlled increases precision by comparison with a manual movement. In an alternative embodiment of the invention, the functions of the control device can also be performed manually to some extent.

A subspace is preferably formed by a sectional surface of the component. Within the meaning of this application, the sectional surface preferably has a minimum thickness which is however low by comparison with that of the main surface, i.e. the thickness is preferably at most 5% of the maximum length of the main surface. More preferably, the sectional surface may also be an ideal surface.

By selecting the sectional surface as the subspace, said subspace can be selected so as to be as small as possible, and this makes it easier to identify and compensate for the inaccuracies of the positioning device. Any positioning errors can be rectified in a more efficient manner, since a measuring device does not have to carry out measurements at as many measuring points.

The subregion or subspace preferably corresponds to at most 50%, more preferably at most 10%, particularly preferably at most 5%, of the corresponding work envelope.

Finally, the subregion or subspace can also be formed by a discrete value within the work envelope. As a result, the movement along and/or about the limited axis is completely restricted and, accordingly, also completely compensated for by the movement about and/or along the external axis.

The positioning errors of the positioning device that result from movement about and/or along the limited axis can therefore be largely or completely eliminated. Although this restriction being compensated for by the movement along and/or about the external axis can lead to new positioning errors, the quantity of these errors is much less than the quantity of positioning errors caused by the positioning device. As a result, the overall precision of the processing apparatus can be increased.

Embodiments also provide that the limited movement is a rotational movement about the limited axis. This makes it possible to efficiently process in particular rotationally symmetrical, or approximately rotationally symmetrical, components, such as the outer or inner flame tube of a combustion chamber of a gas turbine. The limited axis preferably coincides with the axis of symmetry of the component or is oriented in parallel with the axis of symmetry. By performing a corresponding rotational movement about the external axis, the component can thus be rotated until the processing point is in the subspace. Within the subspace, the component can then be accordingly processed by means of the processing tool.

In this case, it is advantageous for the limited axis to be a vertical axis. Accordingly, the external axis is also vertically oriented, such that the component can be positioned, for example, on a rotary table.

Component-specific subspaces are preferably stored on a data carrier. The subspaces can preferably be selected by the control device, such that a suitable subspace for the processing is made available in an efficient manner. Alternatively, it is also possible to determine the subspace by measuring the component to be processed. This can be achieved, for example, by optical measurement methods, in particular by laser measurement methods.

In a preferred embodiment, a measuring device is provided that is designed to detect the position of the processing tool within the subspace. The measuring device is preferably an optical measurement system which can determine the actual position of the positioning device and/or processing tool. A possible deviation of the actual position from a target position, i.e. the positioning error, can be determined and quantified by the control device. By limiting the measurement to the subspace, measurements have to be taken at fewer measuring points, and therefore the measurement can be taken more quickly.

The subspace of the positioning device is advantageously measured once, during start-up. A measurement only has to be taken again if the relative positions change (e.g. if a possible rotary table is repositioned). A high-resolution optical measurement instrument, such as a laser tracker, can be used to carry out this measurement procedure that only has to take place once. This is advantageous in that this measurement procedure only has to be carried out once, and therefore there is no need for complex, permanent monitoring of a possible deviation between the actual position and the target position or for online control of the processing tool.

The measuring device is preferably designed to determine the component state, i.e. to identify any damage. The guidance of the inspection tool can advantageously be limited to the subregion or subspace, such that the optical measuring equipment for detecting or inspecting the component state can be kept in a predetermined position. It is thus not necessary for the measuring equipment, which is preferably attached to the positioning device, to oscillate, and therefore it is possible to detect any damage more quickly.

It is advantageous for a compensation device to be provided in order to rectify positioning errors of the positioning device, the compensation device being designed to manipulate the robot poses to be assumed on the basis of the measured values. By using a subspace, the compensation device only has to compensate for positioning errors within the subspace, and therefore it is quicker to both identify and compensate for positioning errors. Furthermore, more efficient compensation of positioning errors is also achieved by fewer approach points being available for the positioning device within the subspace.

It is also advantageous for a protective gas apparatus to be provided, the protective gas apparatus being designed such that the protective effect is limited to the subspace. Said protective gas apparatus is preferably a protective gas apparatus that is adapted to the component contour. Limiting the protective gas supply to the subspace results in protective gas being saved, and therefore the manufacturing costs can be reduced. Finally, the environmental impact is also reduced and occupational safety is increased. However, the limitation of the protective gas effect to the subspace can also result in more complex weld seam geometries, for example. The protective gas apparatus is preferably a stationary protective gas apparatus.

A method for repairing a component is also proposed according to the invention, the repair being carried out using the apparatus according to the invention.

During the method, a processing point on the component is preferably moved, within the workspace, into a predefined subspace by means of movement along and/or about an external axis, the processing point then being processed by means of a processing tool that is moved within the subspace. Movement along and/or about the limited axis can thus be completely prevented and compensated for by the movement along and/or about the external axis.

The subspace is preferably formed by a sectional surface of the component, and during processing the processing tool is preferably only moved in the plane of the sectional surface. The processing tool thus substantially only has to perform a two-dimensional movement, as a result of which the quantity of positioning errors can be reduced.

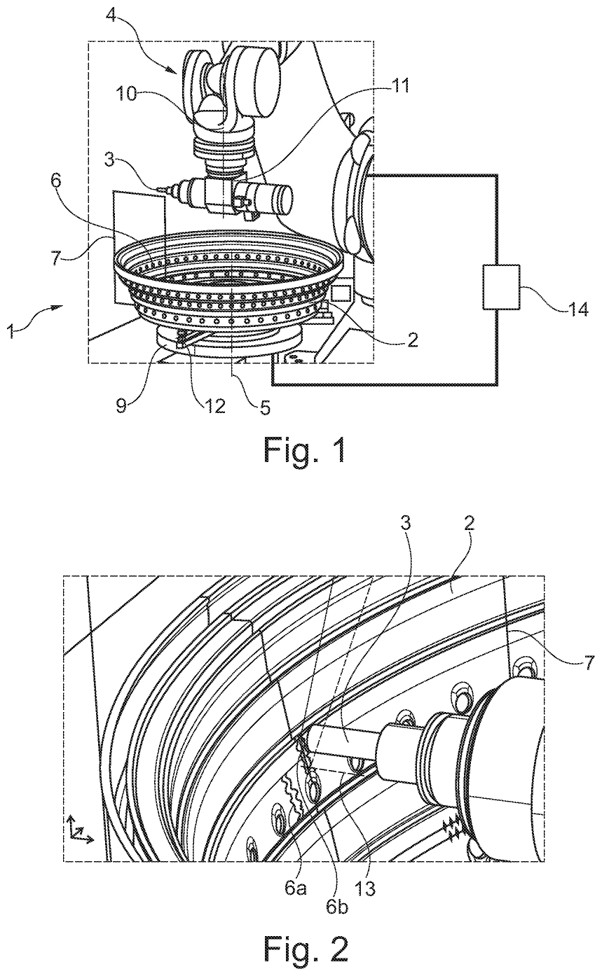

FIG. 1 shows an apparatus 1 according to the invention for processing a component 2, comprising a processing tool 3, a positioning device 4 and a rotary table 9. A subspace 7 is schematically shown in the form of a rectangular area.

In this embodiment, the component 2 to be processed is an approximately rotationally symmetrical combustion chamber component of a gas turbine. However, it is in addition also possible to process any other type of component 2 by means of the apparatus 1 according to the invention.

The processing tool 3 is preferably a machining, joining or material-applying tool, for example a milling cutter, a boring device, a lathe tool, an abrasive cutoff wheel, a welding device, or a laser boring and/or cutting device optionally having a beam interceptor. A receiving portion 11 is more preferably provided that connects the processing tool 3 to the positioning device 4. The receiving portion 11 is preferably designed for replacing the processing tool 3 either manually or automatically. In addition to the processing tool 3, a measuring device is preferably also provided on the receiving portion 11 of the positioning device 4.

The multi-axis positioning device 4 is preferably a six-axis positioning device 4, such that it is possible for the processing tool 3 to be moved relative to the component 2 in any manner. The workspace is thus delimited by the movement axes of the positioning device 4 and the relevant work envelope thereof The work envelope specifies in an axis-specific manner which translational or rotational movements along or about a corresponding axis are possible.

The component 2 to be processed is also positioned on the rotary table 9 of which the rotational axis forms an external axis 5. The external axis 5 is preferably vertically oriented and is preferably parallel to a limited axis 10 of the positioning device 4. In an alternative embodiment, the limited axis 10 can preferably also coincide with the external axis 5.

Within the meaning of this invention, the external axis 5 is characterised in that the additional degree of freedom produced thereby would not be required in order for a corresponding processing point 6 on the component 2 to be reached. This is also the case in this embodiment since, as can be seen from FIG. 1, the processing point 6 can be reached not only by rotating the component 2 about the external axis 5 by means of the rotary table 9, but also by rotating the processing tool 3 about the limited axis 10 of the positioning device 4. In general, rotation about the external axis 5 results in the relevant processing point being rotated into the subspace or around the sectional plane of the component, and the robot 4 moves from the processing points along a line that is vertical in this case. Therefore, any rotational movement is performed proceeding from the external axis 5 and only the vertical movement is performed by the robot 4.

Furthermore, an electronic control device 14 (shown only schematically in FIG. 1), for example a computer, is provided that is designed to limit the movement range of the positioning device 4 and thus the processing tool 3, specifically the tool centre point (TCP), to a subspace. This subspace is part of the overall work envelope of the robot 4.

In FIG. 1, the subspace is shown such that it is reduced to one plane. In order to achieve the mentioned advantages of the method (correction values for increasing accuracy; stationary protective gas supply, etc.) as efficiently as possible, it is expedient for the subspace to be selected so as to be as small as possible. In this case, it is not just the dimensions, i.e. height, width and length, of the subspace that can be limited, but rather also the possible orientation variations (rotation of the TCP about the three axes of the xyz coordinate system). Accordingly, the movement range along or about at least one limited axis 10, but advantageously along or about a plurality of limited axes, within the corresponding work envelope is limited to one subregion. In FIG. 1, the rotary table 9 rotates the component 2 about the rotational axis 5 into the subspace 7, which has been limited to a 2D plane, i.e. a length dimension has been eliminated. Accordingly, the positioning device 4 only has to move to positions within the subspace 7. Since the tool 3 only has to operate perpendicularly to the component surface, in addition to a length dimension, two orientation variables can also be eliminated since the tool only has to be rotated within the subspace. The additional degrees of freedom of the positioning device 4 are however maintained, such that the processing tool 3 can be translated and rotated within a subspace 7.

From another possible point of view, the work envelope is defined as 360° with respect to the possibility of rotation of the positioning device 4 about the axis 10. By specifying a subregion within the work envelope, rotation about the axis 10 can be completely prevented, i.e. the subregion is set at a discrete value with respect to the possibility of rotation about the axis 10. At least one degree of freedom of the positioning device 4 is thus limited by the control device 14.

The limited possibility of movement of the positioning device 4 is compensated for by the additional degree of freedom produced by the rotary table 9 being rotated about the external axis 5. Alternatively or in addition, limitation of the possibility of movement of the positioning device 4 brought about by the control device 14 can also be compensated for by a translational movement along an external axis 5.

If a movement, for example a rotational movement, about the limited axis 10 is not completely restricted, but is instead limited to a predefined angular range by the control device 14, the limited movement has to be compensated for by a corresponding possibility of movement about the external axis 5. If, for example, the rotational movement of the positioning device 4 about the limited axis 10 were to be limited to an angle of at most 25°, rotation about an external axis 5 that coincides with the limited axis 10 through at least 335° would have to be possible in order for the entire possible processing range of 360° to be covered.

The movement about or along the external axis 5 is preferably implemented by the component 2 to be processed being appropriately supported, for example by using the rotary table 9. In an alternative embodiment, the entire positioning device 4 can however also be supported such that movement along or about the external axis 5 is possible.

In the embodiment shown in FIG. 1, the component 2 to be processed is securely positioned on the rotary table 9 by means of a plurality of support elements 12. Furthermore, an actuation device is preferably provided that is designed to rotate the rotary table 9 about the external axis 5 in a predefined manner. The actuation device is preferably controlled by the control device 14 such that the restriction to the possibility of movement of the positioning device 4 can be compensated for in a targeted manner.

FIG. 2 shows a plurality of processing points 6a and 6b, in this case cracks, on the component 2 that are intended to be processed by means of the machining tool 3, in this case a milling device. The rotary table 9, and thus the component 2, being rotated about the external axis 5 results in the processing point 6b first being moved into the subspace 7, which is formed by a rectangular area in this case. After the processing point 6b has been processed, the processing point 6a is moved into the subspace by the rotary table 9 being rotated. Alternatively, the subspace 7 can also be formed by any other space geometries. The processing tool 3 is preferably also oriented in parallel with the planar subspace 7. More preferably, a possible rotational axis or a central processing point of the processing tool 3 is located in the plane of the planar subspace 7.

The control device 14 is preferably designed to automatically select a suitable subspace 7, for example from a data store. Said store contains not only the geometry of the subspace 7, but also the arrangement thereof relative to the component 2.

The subspace 7 can be positioned and oriented in any manner, provided that it is a portion of the workspace of the positioning device 4. Care should preferably be taken to ensure that collisions and singularities are prevented and processing on the axis and workspace boundaries is prevented. In this embodiment, the planar subspace 7 is preferably arranged perpendicularly, the subspace 7 preferably also being oriented perpendicularly to a central axis 13 of the processing point 6. Since the component 2 is oriented horizontally above the support elements 12 and is preferably also clamped in this position, it is possible for the processing point 6 or the central axis 13 thereof to be moved into the subspace 7 merely by the rotary table 9 being rotated about the external axis 5. Even if the subspace is not oriented perpendicularly, the rotary table 9 can rotate the processing point into the subspace. Furthermore, it is irrelevant that the axis 5 of the rotary table is parallel to a robot axis or coincides therewith. This feature from FIG. 1 is not required in order for the method to be carried out.

The position of the processing point 6 relative to the subspace 7 can be monitored and controlled by means of a measuring device, such that, even during the processing operation, it is ensured, for example by processing forces, that the processing point 6 is not moved out of the subspace 7. This makes it possible to achieve a high level of process quality and stability.

Since it is possible for the processing point 6 to be moved into the subspace 7 by means of rotation about the external axis 5, the rotation about the limited axis 10 can preferably be completely blocked by the control device 14. The processing tool 3 then only has to be moved within the subspace 7 so as to be brought into the processing position, and therefore a significantly simpler and shorter movement has to be performed by the positioning device 4 by comparison with a movement of the processing tool 3 in the entire workspace, and this reduces the quantity of positioning errors. The movement of the processing tool 3 during the actual processing operation is also preferably carried out only within the subspace 7, and therefore the processing quality can also be improved.

A compensation device is also provided which is connected to a measuring device. The measuring device is designed to detect the actual position of the processing tool 3 relative to the component 2. A deviation of the actual position from the target position can then be rectified by means of the compensation device. As a result of the processing point 6 being moved into the subspace 7 by means of a rotation about the external axis 5, the positioning device 4 itself has to perform significantly fewer positioning movements. The rotational movement about the external axis 5 by means of the rotary table 9, which is significantly more stable in terms of its position, is also less susceptible to errors. In this way, the quantity of rectifying actions by the compensation device can be reduced, and a higher overall level of precision of the apparatus 1 can thus be achieved.

After the processing point 6 has been processed, the further processing points 6a and 6b can be processed one after the other in the same way. For this purpose, the respective processing points 6a and 6b are moved into the subspace 7, one after the other, by the component 2 being rotated about the external axis 5 and are accordingly processed by means of the processing tool 3.

A further advantage of limiting the movement of the processing tool 3 (for example a milling cutter or a welding nozzle) to the subspace 7 is that use of protective gas can be limited to the subspace 7. A protective gas apparatus that is adapted to the component contour is therefore preferably provided. The protective gas apparatus is more preferably designed to supply protective gas only to the subspace 7, or even only to a part of the subspace 7 that is currently in the processing zone. In an alternative embodiment, however, it may be expedient, for design reasons, for an edge region surrounding the subspace 7 to also be supplied with protective gas by the protective gas apparatus. The protective gas is advantageously provided so as to surround the component. The edge region is preferably determined by a region that is preferably no more than 30 cm, more preferably no more than 10 cm, and particularly preferably no more than 5 cm, away from the subspace. The size of the edge region or the region shielded by protective gas is dependent on the component geometry; either the entire component or just the processing zone has to be shielded by protective gas. By means of the protective gas apparatus according to the invention, the effect of which is limited to the subspace 7 or to the subspace 7 together with the edge region, protective gas can be saved and thus the processing procedure can be more efficient. The same applies to a possible beam interceptor that is locally limited to the subspace and edge region in order to prevent damage to the rear face of the component by laser irradiation. Furthermore, occupational safety can also be increased by spatially limiting the use of protective gas.

Finally, the processing quality can be increased further by defining the subspace 7 in an intelligent manner. In principle, the aim is to select the subspace 7 so as to be as small as possible since this minimises the less precise movements of the positioning device 4 and replaces said movements with the more precise movements about and/or along the external axis 5. Therefore, the subspace 7 is preferably formed by a sectional surface 8 of the component 2. More preferably, in the case of a rotationally symmetrical component 2, said subspace is the sectional surface 8 that passes through the component 2 in the radial direction.

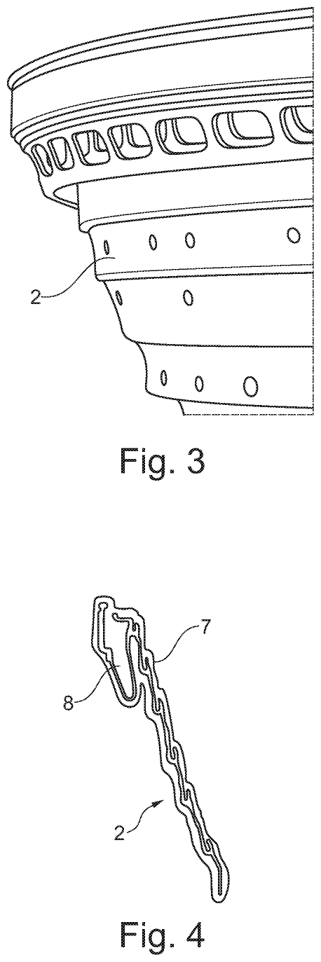

FIG. 3 is a side view of a rotationally symmetrical combustion chamber component 2 of a gas turbine, and FIG. 4 is a schematic cross section thereof. The subspace 7 is preferably formed directly by the border of the cross-sectional surface of the component 2. More preferably, as shown in FIG. 4, the subspace 7 can however also be located around the cross profile at a certain distance therefrom. This distance is preferably no more than 5 cm, more preferably no more than 5 mm. The reason for this is also that the component may be deformed. Furthermore, in a previous measurement step (e.g. using the method from DE 10 2011 103003 A1), deformations of the component can be detected and the size of the required subspace adaptively determined thereby. This distance from the actual sectional surface 8 of the component 2 ensures that the processing tool 3 is at a safe distance from the component 2 during movement about and/or along the external axis 5 and that this cannot result in damage. An appropriately small subspace 7 can thus be defined, such that a high level of precision can be achieved during processing.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related categories or otherwise. Moreover, the recitation of “A,B, and/or C” or “at least one of A, B, or C” should be interpreted as including any singular entity from the listed element, e.g., A, any subset from the listed elements, e.g., A and B, or the entire list of elements A, B, and C.

1: An apparatus for processing a component, the apparatus comprising:
a multi-axis positioning device;
a processing tool; and
a control device for controlling the multi-axis positioning device,
the multi-axis positioning device being configured to move the processing tool relative to the component and to move each axis of,
the processing tool within a corresponding work envelope,
wherein
the control device is configured to limit the movement of the multi-axis positioning device along or about at least one limited axis within the corresponding work envelope to a subregion or subspace, and
the multi-axis positioning device and/or the component is configured to move about and/or along an external axis to compensate for the limitation of the movement along or about the limited axis.

2: The apparatus according to claim 1, wherein
the movement about and/or along the external axis is controlled by the control device.

3: The apparatus according to claim 1, wherein
the subspace corresponds to a sectional surface of the component.

4: The apparatus according to claim 1, wherein
the subregion or the subspace corresponds to at most 50% of the corresponding work envelope.

5: The apparatus according to claim 1, wherein
the subregion or the subspace corresponds to a discrete value within the corresponding work envelope.

6: The apparatus according to claim 1, wherein
the limited movement comprises at least one limited rotational movement about the at least one limited axis.

7: The apparatus according to claim 1, wherein
the limited axis comprises at least one vertical axis.

8: The apparatus according to claim 1, wherein
component-specific subspaces are stored on a data carrier.

9: The apparatus according to claim 1, further comprising
a protective gas apparatus,
the protective gas apparatus being configured such that its protective effect is limited to the subspace.

10: A method for repairing a component, wherein
the repair is carried out using the apparatus according to claim 1.

11: The method according to claim 10, wherein
a processing point on the component is moved within a workspace into a predefined subspace by a movement along and/or about the external axis, and
the processing point is then processed by the processing tool that is moved within the subspace.

12: The method according to claim 10, wherein
the subspace is formed by a sectional surface of the component, and
during processing, the processing tool is only moved in the plane of the sectional surface.
